(19) United States
(12) Patent Application Publication
(10) Pub. No.: US 2019/0233275 A1
(43) Pub. Date: Aug. 1, 2019

(54) METHOD AND APPARATUS FOR METERING FLOW DURING CENTRALIZED WELL TREATMENT

(71) Applicant: HALLIBURTON ENERGY SERVICES, INC., Houston, TX (US)

(72) Inventors: Jared Michael CARR, Williston, ND (US); Beauden Richard SCHNEIDER, Williston, ND (US); Patrick Barrett SIEVERT, Sidney, MT (US); Russell Ray LOCKMAN, Commerce City, CO (US)

(21) Appl. No.: 15/885,198

(22) Filed: Jan. 31, 2018

(51) Int. Cl. B67D 7/02; B67D 7/70; B67D 7/36; B67D 7/62

(52) U.S. Cl. CPC B67D 7/02; B67D 7/70; E21B 43/26; B67D 7/62; B67D 7/0288; B67D 7/36

(57) ABSTRACT

A system for providing a well stimulation fluid can include a manifold, a first flow meter and a second flow meter. The manifold can be an integrated manifold defining a first isolated manifold path and a second isolated manifold path. The first isolated manifold path can be configured to be in fluid communication with a first wellhead and the second isolated manifold path is configured to be in fluid communication with a second wellhead. The first flow meter can be in fluid communication with the first isolated manifold path. The second flow meter can be in fluid communication with the second isolated manifold path.

### TECHNICAL FIELD

The present description relates in general to well operations, and more particularly, for example and without limitation, to methods and apparatuses for simultaneously treating multiple wells from a centralized location.

### BACKGROUND OF THE DISCLOSURE

In the production of oil and gas in the field, it is often required to stimulate and treat several well locations within a designated amount of time. Stimulation and treatment processes often involve mobile equipment that is set up at a pad location and is then moved by truck from pad to pad within short time periods.

The movement of equipment and personnel can involve complex logistics. The servicing and stimulation of wells can require a series of coordinated operations that begin with the delivery of equipment, supplies, fuel, and chemicals to the wellhead. The equipment is then set up and made ready with proppant and chemicals. After completion of the well services, equipment must be broken down and made ready for transport to the next pad for service. Often, the next pad will be less than 500 feet away from the previously treated pad. In addition, due to the limited storage capacity of the moving equipment for chemicals and equipment, additional trucks are often required to resupply and reequip an existing operation. This movement of equipment and supplies has environmental impacts, and the exposure of mobile equipment to adverse weather conditions can jeopardize well treatment operations and worker safety.

### BRIEF DESCRIPTION OF THE DRAWINGS

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

FIG. 1 is a flow diagram of a centralized well treatment facility that can employ the principles of the present disclosure.

FIG. 2 is a diagram of a manifold for use with the centralized well treatment facility of FIG. 1, according to some embodiments of the present disclosure.

FIG. 3 is a diagram of a manifold for use with the centralized well treatment facility of FIG. 1, according to some embodiments of the present disclosure.

FIG. 4 is a flow diagram of a centralized well treatment facility, according to some embodiments of the present disclosure.

FIG. 5 is a flow diagram of a centralized well treatment facility, according to some embodiments of the present disclosure.

FIG. 6 is a flow diagram of a centralized well treatment facility, according to some embodiments of the present disclosure.

FIG. 7 is a diagram of a manifold for use with the centralized well treatment facility of FIG. 6, according to some embodiments of the present disclosure.

### DETAILED DESCRIPTION

This section provides various example implementations of the subject matter disclosed, which are not exhaustive. As those skilled in the art would realize, the described implementations may be modified without departing from the scope of the present disclosure. Accordingly, the drawings and description are to be regarded as illustrative in nature and not restrictive.

The present description relates in general to well operations, and more particularly, for example and without limitation, to methods and apparatuses for simultaneously treating multiple wells from a centralized location.

Simultaneous well stimulation and treatment processes from a centralized location can simplify logistics and reduce operation time and costs. In some applications, a single fracturing crew or fleet can increase their productivity by fracturing multiple wells from a centralized location without the need for additional blending equipment or personnel. However, as multiple wells are simultaneously stimulated or treated from a central location, an operator may not be able to monitor fluid flow to each well treated from the centralized location.

An aspect of at least some embodiments disclosed herein is that by monitoring fluid flow from a centralized location to multiple wells, operators can have enhanced control over the multiple wells while operating from a centralized location.

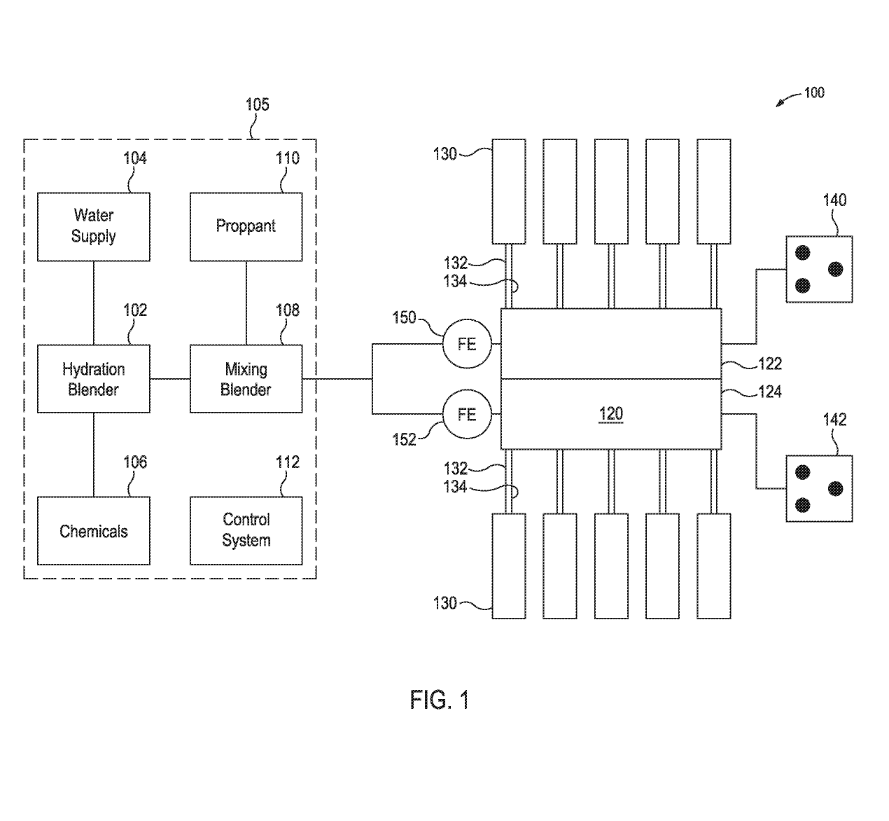

FIG. 1 is a flow diagram of a centralized well treatment facility that can employ the principles of the present disclosure. Multiple wells, such as the first well 140 and the second well 142 can be treated or stimulated simultaneously using the centralized well treatment facility 100. The well treatment facility 100 can be set upon a pad from which at least the first well 140 and the second well 142 can be serviced. In some embodiments, the well treatment operations facility 100 can be connected to at least the first well 140 and the second well 142 via a central manifold 120. Connections within the well treatment facility 100 may be a standard piping or tubing known to one of ordinary skill in the art. The well treatment facility 100 can include a centralized location 105 that includes at least some of the components of the well treatment facility 100 and may be open, or may be at least partially enclosed with various combinations of structures including a supported fabric structure, a collapsible structure, a prefabricated structure, a retractable structure, a composite structure, a temporary building, a prefabricated wall and roof unit, a deployable structure, a modular structure, a preformed structure, or a mobile accommodation unit.

Advantageously, the well treatment facility 100 allows for fluids for treatment, stimulation, fracturing, or other well operations to be manufactured, formed and/or mixed at a centralized location 105 prior to being transferred to the first well 140 and the second well 142. In some embodiments, well fluids can be created by optionally mixing constituents in a hydration blender 102 before mixing the fluid in a mixing blender 108. In some embodiments, water from a water supply 104 and dry powder can be introduced into the hydration blender 102. Dry powder, such as guar can be metered into the hydration blender 102 from a storage tank via a screw conveyor. In some embodiments, various chemical additives and modifiers can be introduced into the hydration blender 102 from a chemical storage system 106.

In some embodiments, the chemical storage system 106 is connected to the hydration blender 102 and can include tanks for breakers, gel additives, crosslinkers, and liquid gel concentrate. The tanks can have level control systems such as a wireless hydrostatic pressure system and may be insulated and heated. Pressurized tanks may be used to provide positive pressure displacement to move chemicals, and some tanks may be agitated and circulated. The chemical storage system 106 can continuously meter chemicals with additive pumps, which are able to meter chemical solutions to the hydration blender 102 at specified rates as determined by the required final concentrations and the pump rates of the main treatment fluid from the hydration blender 102. In some embodiments, chemical storage tanks of the chemical storage system 106 are pressurized to drive fluid flow. The quantities and rates of chemicals added to the main fluid stream may be controlled by valve-metering control systems. In addition, chemical additives can be added to the main treatment fluid in the hydration blender 102 via aspiration (Venturi Effect). The rates that the chemical additives are aspirated into the main fluid stream can be controlled via adjustable, calibrated apertures located between the chemical storage system 106 and the hydration blender 102. In some embodiments, the components of the chemical storage system 106 are modularized allowing pumps, tanks, or blenders to be added or removed independently.

After pre-mixing in the hydration blender 102, the treatment or fracturing fluid can be further mixed in the mixing blender 108. In some embodiments, mixing can occur solely in the mixing blender 108 without any pre-mixing in the hydration blender 102. In some embodiments, the mixing blender 108 can be utilized to introduce, mix and blend proppant and chemical additives into a base fluid. Mixing can be accomplished at downhole pump rates. In some embodiments, the mixing blender 108 is configured to blend proppant and chemical additives into the base fluid without destroying the base fluid properties while still providing ample energy for the blending of proppant into a near fully hydrated fracturing fluid. In some embodiments, the mixing blender 108 is a modified Halliburton Growler mixer.

Proppant can be introduced into the mixing blender 108 from a proppant storage system 110. In some embodiments, the proppant storage system 110 can include automatic valves and a set of tanks that contain proppant. Each tank can be monitored for level, material weight, and the rate at which proppant is being consumed. This information can be transmitted to a controller or control area. Each tank is capable of being filled pneumatically and can be emptied through a calibrated gravity discharge. Tanks may be added to or removed from the proppant storage system 110 as needed. Empty storage tanks can be replenished as full or partially full tanks are being used, allowing for continuous operation. The tanks can be arranged around a calibrated v-belt conveyor. In addition, a resin-coated proppant may be used by the addition of a mechanical proppant coating system. In some embodiments, the coating system may be a Muller System.

In some embodiments, the mixed or manufactured fluid from the mixing blender 108 can be pumped simultaneously to the first well 140 and the second well 142 via a manifold 120. In some embodiments, the manifold 120 can be isolated into a first isolated manifold path 122 directed to the first well 140 and a second isolated manifold path 124 directed to the second well 142. The first isolated manifold path 122 and the second isolated manifold path 124 can be integrated in a single manifold 120, which may be referred to as a “missile.” The use of the manifold 120 can allow multiple wells to be fractured or treated simultaneously.

Treatment or fracturing fluid can be transferred, transported, and/or pressurized within the first isolated manifold path 122 and the second isolated manifold path 124 via an array of pumps 130. The array of pumps 130 can be fluidly connected to the first isolated manifold path 122 via suction lines 132 and discharge lines 134. A separate array of pumps 130 can be can be fluidly connected to the second isolated manifold path 124 via suction lines 132 and discharge lines 134. The pumps 130 within the arrays can be electric, gas, diesel, or natural gas powered. In some embodiments, the pumps 130 can be modularized for ease of configuration. In some embodiments, the output and pressure of the pumps 130 can be adjusted in response to sensor data, such as data received from the first flow meter 150 and the second flow meter 152.

As treatment or fracturing fluid flows from a centralized location 105 to the first well 140 and the second well second 142 via the manifold 120, a first flow meter 150 in fluid communication with the first isolated manifold path 122 and a second flow meter 152 in fluid communication with the second isolated manifold path 124 can provide an operator and/or a control system 112 with flow rate and total flow information. Advantageously, the first flow meter 150 and the second flow meter 152 can provide flow information about each flow to the first well 140 and the second well 142 for precise measurement and regulation. Flow measurements for the first well 140 and the second well 142 can allow for enhanced control of treatment or fracturing of both the first well 140 and the second well 142 while allowing for the benefits of a centralized well treatment facility 100 as described herein. The first flow meter 150 and the second flow meter 152 can be disposed along any suitable portion of the first isolated manifold path 122 and the second isolated manifold path 124, respectively.

The first flow meter 150 and the second flow meter 152 can be any suitable type of flow meter, including, but not limited to an orifice plate, Pitot tube, averaging Pitot tube, flume, weir, turbine, target, positive displacement, rotameter, vortex, Coriolis, ultrasonic, magnetic, wedge, v-cone, flow nozzle, and/or Venturi type flow meters. The flow meters can be utilized to measure mass and/or volumetric flow rates of the fluid. Information from the first flow meter 150 and the second flow meter 152 can be transmitted to a display and/or a control system 112.

In some embodiments, information from the first flow meter 150 and/or the second flow meter 152 can be utilized to control the production of fluid and the output of fluid to the first well 140 and the second well 142. In some embodiments, the operations of the chemical storage system 106, hydration blender 102, proppant storage system 110, mixing blender 108, manifold 120, and/or pumps 130 are controlled, coordinated, and monitored by a central control system 112. The central control system 112 may utilize sensor data including information from the first flow meter 150 and the second flow meter 152 as well as operating parameters from the chemical storage system 106, hydration blender 102, proppant storage system 110, mixing blender 108, manifold 120, and pumps 130 to identify operation of the well treatment facility 100. In some embodiments, the control system 112 can be utilized to adjust the output of the pumps 130 by utilizing flow data from the first flow meter 150 and the second flow meter 152 in light of fluid flow targets for the first well 140 and/or the second well 142. In some embodiments, fluid flow to the first well 140 and/or the second well 142 can be exclusively controlled by adjusting the output of the pumps 130. Further, information from the first flow meter 150 and the second flow meter 152 can be utilized to control desired fluid properties such as density, rate, viscosity, etc. Flow information can also be utilized to identify dynamic or steady state bottlenecks within the well treatment facility 100. The central control system 112 can also be used to monitor equipment health and status.

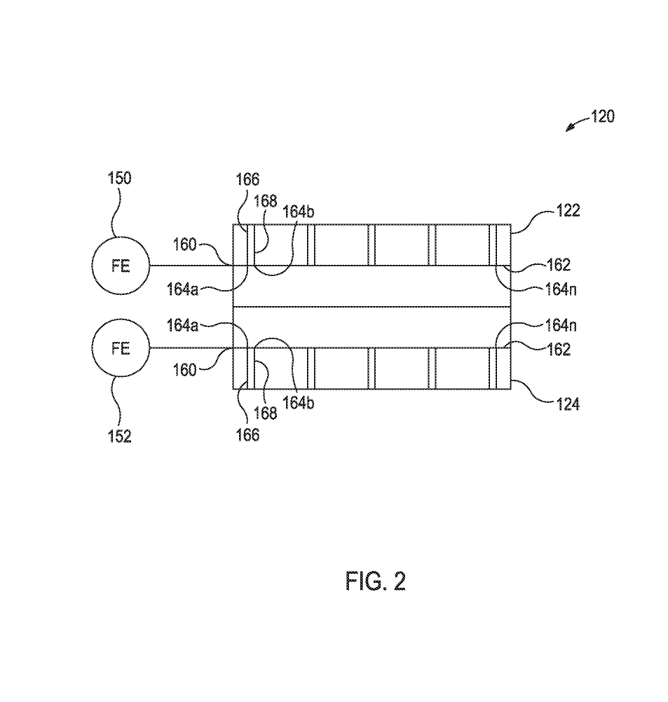

FIG. 2 is a diagram of a manifold for use with the centralized well treatment facility of FIG. 1, according to some embodiments of the present disclosure. In some embodiments, the manifold 120 is an integrated manifold that defines a first isolated manifold path 122 and a second isolated manifold path 124 within an integrated body.

In some embodiments, an inlet 160 of the first isolated manifold path 122 can receive a fluid flow from the mixing blender 108. As fluid flow is directed into the first isolated manifold path 122, the first flow meter 150 can measure flow rate therethrough. The first isolated manifold path 122 can direct the flow of fluid from the inlet 160 to the outlet 162 while allowing the fluid flow therethough to be pressurized via the array of pumps 130. The outlet 162 can direct the pressurized fluid flow to the first well 140.

In the depicted example, the suction ports 166 and the discharge ports 168 can be in fluid communication with the first isolated manifold path 122 at junctions or nodes 164a-164n.

In some embodiments, the suction ports 166 of the first isolated manifold path 122 allow pumps 130 to receive a fluid flow from the first isolated manifold path 122. The discharge ports 168 provide the pumped fluid from the pumps 130 back to the first isolated manifold path 122.

As shown in FIG. 2, the second isolated manifold path 124 can have a similar configuration as the first isolated manifold path 122. The second isolated manifold path 124 can similarly receive fluid flow from the mixing blender 108 via an inlet 160. The second flow meter 152 can measure fluid flow through the second isolated manifold path 124. The second isolated manifold path 124 can direct the flow of fluid from the inlet 160 to the outlet 162 while allowing the fluid flow therethough to be pressurized via the array of pumps 130. The outlet 162 can direct the pressurized fluid flow to the second well 142.

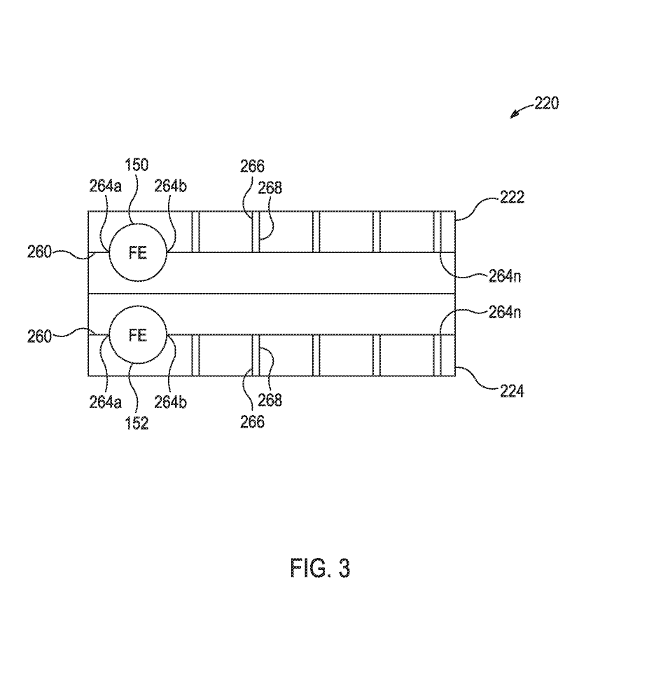

FIG. 3 is a diagram of a manifold for use with the centralized well treatment facility of FIG. 1, according to some embodiments of the present disclosure. Referring to FIG. 3, in some embodiments, manifold 220 can include a first flow meter 150 and/or a second flow meter 150 within the manifold 220 along the first isolated manifold path 222 and/or the second isolated manifold path 224. In some embodiments, the manifold 220 can include various valves and sensors along the first isolated manifold path 222 and/or the second isolated manifold path 224.

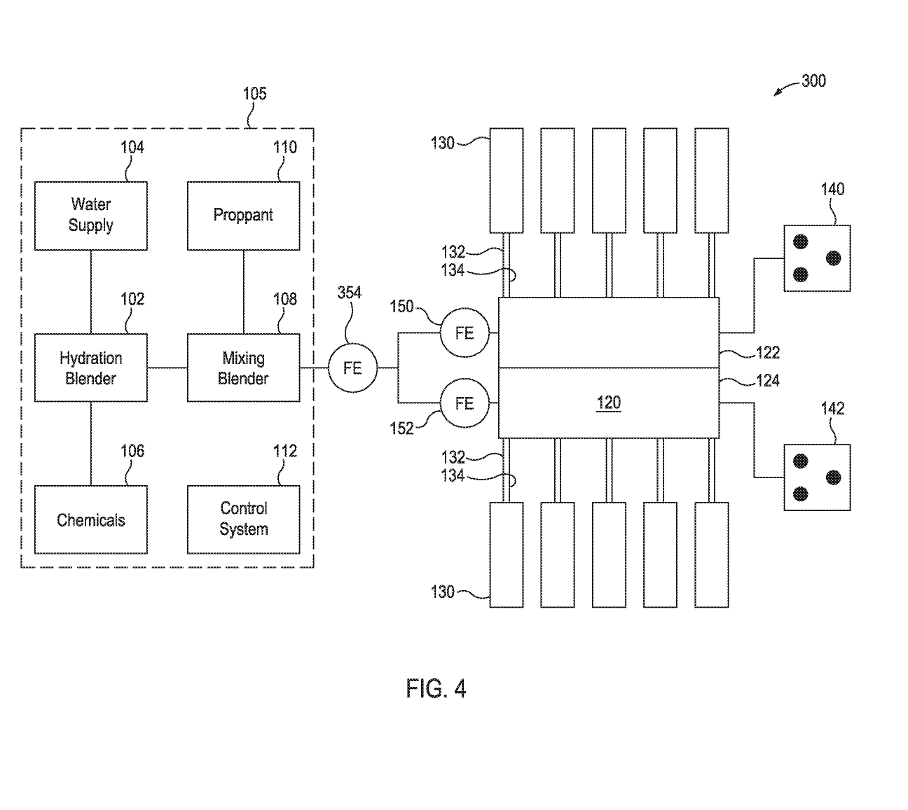

FIG. 4 is a flow diagram of a centralized well treatment facility that can employ the principles of the present disclosure. In some embodiments, the well treatment facility 300 can include an additional flow meter 354 disposed downstream of the mixing blender 108 to measure the flow from the mixing blender 108 before the flow is separated and directed into the first isolated manifold path 122 and the second isolated manifold path 124 of the manifold 120. The flow meter 354 can provide total flow and/or flow rates out of the mixing blender 108.

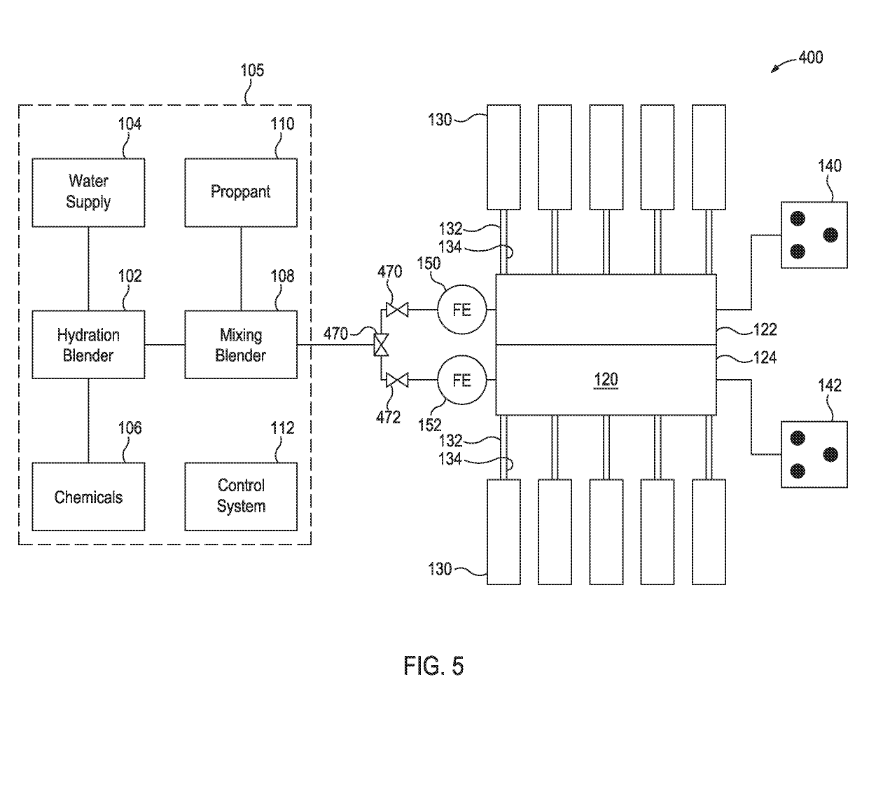

FIG. 5 is a flow diagram of a centralized well treatment facility that can employ the principles of the present disclosure. In some embodiments, the well treatment facility 400 can optionally include a first valve 470 disposed along the first isolated manifold path 122 and/or a second valve 472 disposed along the second isolated manifold path 124. The first valve 470 can be utilized to control the flow from the mixing blender 108 to the first well 140 and the second valve 472 can be utilized to control the flow from the mixing blender 108 to the second well 142. The first valve 470 and the second valve 472 can be disposed outside of the manifold 120 or disposed within the manifold 120. The first valve 470 and the second valve 472 can allow for the first well 140 and the second well 142 to each be stimulated individually by opening the respective first valve 470 or the second valve 472 and closing the other valve. Further, in some embodiments, the first valve 470 and the second valve 472 can be used to control the flow rate to the first well 140, the second well 142, or to both the first well 140 and the second well 142 simultaneously.

In some embodiments, the well treatment facility 400 can optionally include a proportioning valve 474 in place of, or in addition to, the first valve 470 and the second valve 472. The proportioning valve 474 can control and direct the flow from the mixing blender 108 to the first isolated manifold path 122 and the second isolated manifold path 124. The proportioning valve 474 can separate or direct flow completely to the first isolated manifold path 122, to the second isolated manifold path 124, or to a combination of the first isolated manifold path 122 and the second isolated manifold path 124 at a desired proportion. The proportioning valve 474 can be used in conjunction with, or separate from, the first valve 470 and the second valve 472.

In some embodiments, the control system 112 can be utilized to control the position of the first valve 470, second valve 472, and/or the proportioning valve 474 by utilizing flow data from the first flow meter 150 and the second flow meter 152 in light of fluid flow targets for the first well 140 and/or the second well 142.

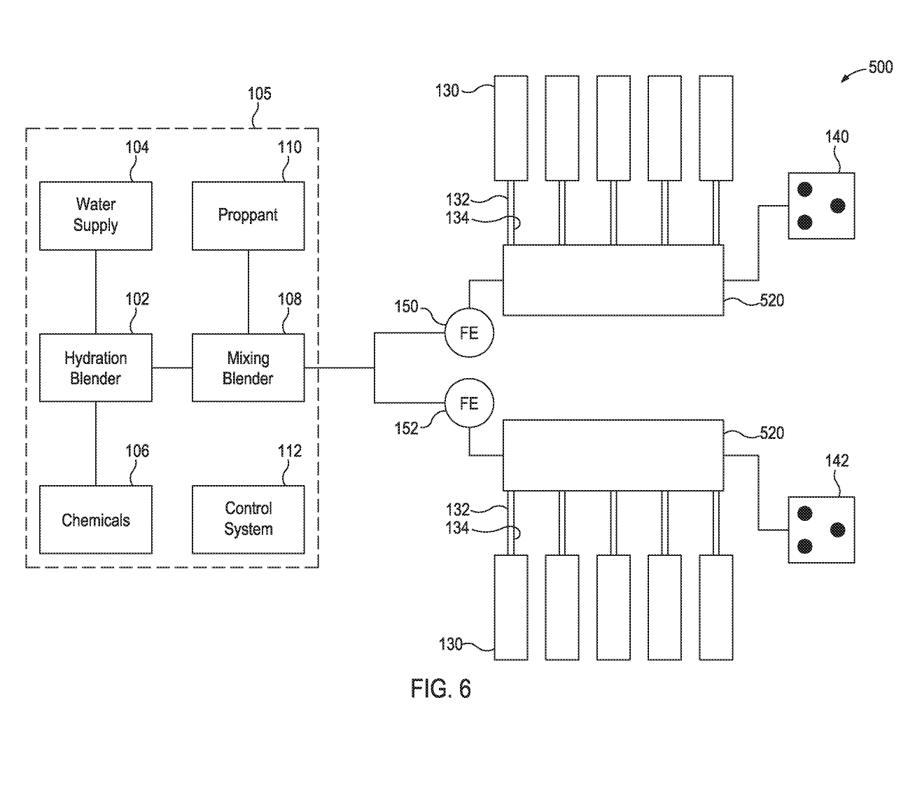

FIG. 6 is a flow diagram of a centralized well treatment facility that can employ the principles of the present disclosure. In some embodiments, the well treatment facility 500 can utilize multiple manifolds 520 instead of a single integrated manifold. Each manifold 520 can receive a flow from the mixing blender 108 and direct the flow to either the first well 140 or the second well 142. In some embodiments, the separate manifolds 520 can be manifold trailers or other modular manifold assemblies.

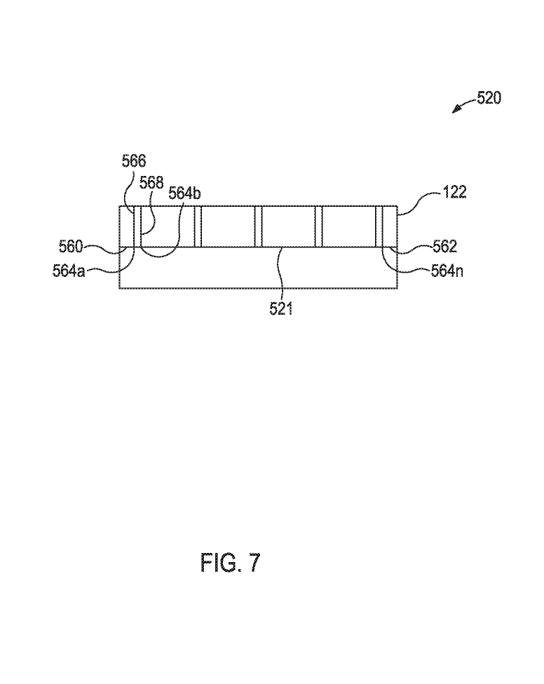

FIG. 7 is a diagram of a manifold for use with the centralized well treatment facility of FIG. 6, according to some embodiments of the present disclosure. In some embodiments, the manifold 520 is provides a single flow path 521 within the manifold 520.

In some embodiments, an inlet 560 of the manifold 520 can receive a fluid flow from the mixing blender 108. As fluid flow is directed into the manifold 520, the first flow meter 150 or the second flow meter 152 can measure flow rate therethrough. The flow path 521 can direct the flow of fluid from the inlet 560 to the outlet 562 while allowing the fluid flow therethough to be pressurized via the array of pumps 130. The outlet 562 can direct the pressurized fluid flow to the first well 140 or the second well 142.

In the depicted example, the suction ports 566 and the discharge ports 568 can be in fluid communication with the flow path 521 at junctions or nodes 164a-164n.

In some embodiments, the suction ports 566 allow pumps 130 to receive a fluid flow from the flow path 521. The discharge ports 568 provide the pumped fluid from the pumps 130 back to the flow path 521.

In some embodiments, the well treatment facility can be used for both onshore and offshore operations using existing or specialized equipment or a combination of both. Such equipment can be modularized to expedite installation or replacement.

Various examples of aspects of the disclosure are described below as clauses for convenience. These are provided as examples, and do not limit the subject technology.

Clause 1. A method, comprising: providing a well stimulation fluid flow comprising a well stimulation fluid; separating the well stimulation fluid flow to a first fluid flow via a first isolated manifold path and a second fluid flow via a second isolated manifold path; measuring a first fluid flow rate corresponding to the first fluid flow via a first flow meter; measuring a second fluid flow rate corresponding to the second fluid flow via a second flow meter; directing the first fluid flow to a first wellhead via the first isolated manifold path; and directing the second fluid flow to a second wellhead via the second isolated manifold path.

Clause 2. The method of Clause 1, further comprising manufacturing the well stimulation fluid.

Clause 3. The method of Clause 2, wherein the manufacturing comprises mixing the well stimulation fluid.

Clause 4. The method of Clause 2, wherein the manufacturing comprises introducing a proppant to the well stimulation fluid.

Clause 5. The method of Clause 2, wherein the manufacturing comprises introducing water to the well stimulation fluid.

Clause 6. The method of Clause 2, wherein the manufacturing comprises introducing chemicals to the well stimulation fluid.

Clause 7. The method of any preceding Clause, wherein the first isolated manifold path and the second isolated manifold path are defined by an integrated manifold.

Clause 8. The method of any preceding Clause, wherein the first isolated manifold path is defined by a first manifold and the second isolated manifold path is defined by a second manifold.

Clause 9. The method of any preceding Clause, further comprising increasing a pressure of the first fluid flow via a first plurality of pumps in fluid communication with the first isolated manifold path.

Clause 10. The method of Clause 9, further comprising adjusting the first plurality of pumps in response to the first flow rate.

Clause 11. The method of any preceding Clause, further comprising increasing a pressure of the second fluid flow via a second plurality of pumps in fluid communication with the second isolated manifold path.

Clause 12. The method of Clause 11, further comprising adjusting the second plurality of pumps in response to the second flow rate.

Clause 13. The method of any preceding Clause, further comprising separating the well stimulation fluid flow via a proportioning valve in fluid communication with the first isolated manifold path and the second isolated manifold path.

Clause 14. The method of Clause 13, further comprising adjusting the proportioning valve in response to the first flow rate or the second flow rate.

Clause 15. The method of any preceding Clause, further comprising controlling the first fluid flow via a first valve disposed within the first isolated manifold path.

Clause 16. The method of Clause 15, further comprising adjusting the first valve in response to the first flow rate.

Clause 17. The method of any preceding Clause, further comprising controlling the second fluid flow via a second valve disposed within the second isolated manifold path.

Clause 18. The method of Clause 17, further comprising adjusting the second valve in response to the second flow rate.

Clause 19. The method of any preceding Clause, further comprising measuring a total fluid flow rate corresponding to the well stimulation fluid flow.

Clause 20. The method of any preceding Clause, wherein directing the first fluid flow to the first wellhead and directing the second fluid flow to the second wellhead is simultaneous.

Clause 21. A system comprising: an integrated manifold defining a first isolated manifold path and a second isolated manifold path, wherein the first isolated manifold path is configured to be in fluid communication with a first wellhead and the second isolated manifold path is configured to be in fluid communication with a second wellhead; a first flow meter in fluid communication with the first isolated manifold path; and a second flow meter in fluid communication with the second isolated manifold path.

Clause 22. The system of Clause 21, further comprising a well stimulation fluid source in fluid communication with the first isolated manifold path and the second isolated manifold path.

Clause 23. The system of Clause 22, wherein the well stimulation fluid source comprises a mixer.

Clause 24. The system of Clause 22, wherein the well stimulation fluid source comprises a hydration blender.

Clause 25. The system of Clause 22, further comprising a third flow meter in fluid communication with the well stimulation fluid source, the first isolated manifold path and the second isolated manifold path.

Clause 26. The system of Clause 22, further comprising a proportioning valve in fluid communication with the well stimulation fluid source, the first isolated manifold path and the second isolated manifold path to direct flow from the well stimulation fluid source to the first isolated manifold path and the second isolated manifold path.

Clause 27. The system of Clauses 21-26, further comprising a first valve disposed within the first isolated manifold path to control flow through the first isolated manifold path.

Clause 28. The system of Clauses 21-27, further comprising a second valve disposed within the second isolated manifold path to control flow through the second isolated manifold path.

Clause 29. The system of Clauses 21-28, further comprising a first plurality of pumps in fluid communication with the first isolated manifold path.

Clause 30. The system of Clauses 21-29, further comprising a second plurality of pumps in fluid communication with the second isolated manifold path.

Clause 31. A system comprising: a first manifold defining a first isolated manifold path configured to be in fluid communication with a first wellhead; a second manifold defining a second isolated manifold path configured to be in fluid communication with a second wellhead; a first flow meter in fluid communication with the first isolated manifold path; and a second flow meter in fluid communication with the second isolated manifold path.

Clause 32. The system of Clause 31, further comprising a well stimulation fluid source in fluid communication with the first isolated manifold path and the second isolated manifold path.

Clause 33. The system of Clause 32, wherein the well stimulation fluid source comprises a mixer.

Clause 34. The system of Clause 32, wherein the well stimulation fluid source comprises a hydration blender.

Clause 35. The system of Clause 32, further comprising a third flow meter in fluid communication with the well stimulation fluid source, the first isolated manifold path and the second isolated manifold path.

Clause 36. The system of Clause 32, further comprising a proportioning valve in fluid communication with the well stimulation fluid source, the first isolated manifold path and the second isolated manifold path to direct flow from the well stimulation fluid source to the first isolated manifold path and the second isolated manifold path.

Clause 37. The system of Clauses 31-36, further comprising a first valve disposed within the first isolated manifold path to control flow through the first isolated manifold path.

Clause 38. The system of Clauses 31-37, further comprising a second valve disposed within the second isolated manifold path to control flow through the second isolated manifold path.

Clause 39. The system of Clauses 31-38, further comprising a first plurality of pumps in fluid communication with the first isolated manifold path.

Clause 40. The system of Clauses 31-39, further comprising a second plurality of pumps in fluid communication with the second isolated manifold path.

What is claimed is:

1. A method, comprising:
providing a well stimulation fluid flow comprising a well stimulation fluid;
separating the well stimulation fluid flow to a first fluid flow via a first isolated manifold path and a second fluid flow via a second isolated manifold path;
measuring a first fluid flow rate corresponding to the first fluid flow via a first flow meter;
measuring a second fluid flow rate corresponding to the second fluid flow via a second flow meter;
directing the first fluid flow to a first wellhead via the first isolated manifold path; and
directing the second fluid flow to a second wellhead via the second isolated manifold path.

2. The method of claim 1, further comprising manufacturing the well stimulation fluid.

3. The method of claim 1, wherein the first isolated manifold path and the second isolated manifold path are defined by an integrated manifold.

4. The method of claim 1, wherein the first isolated manifold path is defined by a first manifold and the second isolated manifold path is defined by a second manifold.

5. The method of claim 1, further comprising increasing a pressure of the first fluid flow via a first plurality of pumps in fluid communication with the first isolated manifold path.

6. The method of claim 5, further comprising adjusting the first plurality of pumps in response to the first flow rate.

7. The method of claim 1, further comprising increasing a pressure of the second fluid flow via a second plurality of pumps in fluid communication with the second isolated manifold path.

8. The method of claim 7, further comprising adjusting the second plurality of pumps in response to the second flow rate.

9. A system comprising:
an integrated manifold defining a first isolated manifold path and a second isolated manifold path, wherein the first isolated manifold path is configured to be in fluid communication with a first wellhead and the second isolated manifold path is configured to be in fluid communication with a second wellhead;
a first flow meter in fluid communication with the first isolated manifold path; and
a second flow meter in fluid communication with the second isolated manifold path.

10. The system of claim 9, further comprising a well stimulation fluid source in fluid communication with the first isolated manifold path and the second isolated manifold path.

11. The system of claim 10, wherein the well stimulation fluid source comprises a mixer.

12. The system of claim 10, wherein the well stimulation fluid source comprises a hydration blender.

13. The system of claim 10, further comprising a third flow meter in fluid communication with the well stimulation fluid source, the first isolated manifold path and the second isolated manifold path.

14. The system of claim 9, further comprising a first plurality of pumps in fluid communication with the first isolated manifold path.

15. The system of claim 9, further comprising a second plurality of pumps in fluid communication with the second isolated manifold path.

16. A system comprising:
a first manifold defining a first isolated manifold path configured to be in fluid communication with a first wellhead;
a second manifold defining a second isolated manifold path configured to be in fluid communication with a second wellhead;
a first flow meter in fluid communication with the first isolated manifold path; and
a second flow meter in fluid communication with the second isolated manifold path.

17. The system of claim 16, further comprising a well stimulation fluid source in fluid communication with the first isolated manifold path and the second isolated manifold path.

18. The system of claim 17, further comprising a third flow meter in fluid communication with the well stimulation fluid source, the first isolated manifold path and the second isolated manifold path.

19. The system of claim 16, further comprising a first plurality of pumps in fluid communication with the first isolated manifold path.

20. The system of claim 16, further comprising a second plurality of pumps in fluid communication with the second isolated manifold path.
